(19) United States
(12) Patent Application Publication
(10) Pub. No.: US 2018/0371759 A1
(43) Pub. Date: Dec. 27, 2018

(54) BREATHABLE COMPOSITE MOISTURE BARRIER ROOFING UNDERLAYMENT

(71) Applicant: HAL Industries, Inc., Surrey (CA)

(72) Inventor: Peter Harco, Surrey (CA)

(21) Appl. No.: 16/020,841

(22) Filed: Jun. 27, 2018

Related U.S. Application Data
(60) Provisional application No. 62/525,679, filed on Jun. 27, 2017.

(51) Int. Cl. E04D 5/02; B32B 7/14; B32B 5/02; B32B 27/10; B32B 5/26; E04D 5/10

(52) U.S. Cl. CPC E04D 5/02; B32B 7/14; B32B 5/022; B32B 5/028; B32B 27/10; B32B 5/26; B32B 2419/06; B32B 2260/028; B32B 2260/042; B32B 2262/02; B32B 2262/101; B32B 2307/724; B32B 2307/718; E04D 5/10

(57) ABSTRACT

A multi-layer laminated roofing underlayment comprising a sheet of asphalt impregnated felt paper bonded to a sheet of porous non-woven polymer fabric in which the bonding adhesive is hot-melt modified asphalt, spot coated onto the felt paper in order to maintain water vapor permeability.

### RELATED APPLICATIONS

This application (Attorney's Ref. No. P219504) claims priority of U.S. Provisional Patent Application Ser. No. 62/525,679 filed Jun. 27, 2017, the contents of which are incorporated herein by reference.

### BACKGROUND AND FIELD OF THE INVENTION

The present invention describes a unique, multi-layered membrane designed for use as a moisture barrier in the field of construction, specifically as an underlayment beneath roofing materials or behind wall claddings, and it relates to a method of producing such a membrane to be both moisture resistant and water vapor permeable.

Roofing underlayments have been utilized in construction of wood frame or metal frame buildings for many decades, almost since the advent of frame construction. Typically these materials were made of heavy paper or felt which was coated or impregnated with bitumen in order to render them water resistant. The bitumen used in modern day paper felt underlayments is a petroleum derivative commonly known as asphalt. Modern paper based roofing felt is a specialized paper containing both recycled paper fiber and wood fibers, impregnated with asphalt bitumen.

One important feature that asphalt felt has is that it is permeable to water vapor. Water vapor permeability is an essential requirement for many applications in the construction of roofs and walls. A second important feature of asphalt roofing felt is that the asphalt contained within the felt will typically seal around nails which attach the superimposed roofing and pass through the felt layer. Sealing around nails is important since every roof typically has thousands of nails holding the shingles in place. If leaks occur in the main roofing material, having an underlayment which can seal around nails can stop the leak from doing further expensive damage to wood decking and other parts of the building. Modern day thin plastic sheets being marketed as roofing underlayments do not contain asphalt and typically contain no “sticky” component to seal around nails, the way asphalt felt does.

During the past two to three decades many plastic based synthetic membranes have been developed specifically for use in construction to perform the same moisture protection function as paper based asphalt impregnated felts. These plastic polymer based sheets are typically marketed as having advantages over the traditional asphalt felts, in that they are lighter and stronger and less prone to damage during installation. Many synthetic membranes being marketed as roofing underlayments are not water vapor permeable. This is a disadvantage where permeability is required.

Asphalt felt technology has not changed in many decades, almost since it was first developed. Some disadvantages of asphalt felt is that it is relatively easy to tear or damage and it can be affected by moisture which may cause it to expand and ripple after fastening in place. The newer synthetic products are stronger and more stable when wet, and are marketed accordingly. Therefore it would be advantageous to develop an improved version of asphalt felt material which would retain its advantages such as sealing around nails and permeability, but eliminate its disadvantages as noted above.

### SUMMARY OF THE INVENTION

The objective of the present invention is to produce a composite material incorporating at least one layer of asphalt felt laminated to one or more layers of synthetic materials which results in an underlayment membrane having improved strength and stability while retaining the water stopping and nail sealing ability of asphalt felt and not sacrificing its water vapor permeability.

### BRIEF DESCRIPTION OF THE DRAWINGS

FIG. 1 shows the components making up the preferred embodiment of the present invention. The asphalt felt layer 100 has spot-coated asphalt 101 on one face, to which is bonded a layer of open scrim 102 and a layer of non-woven synthetic fabric 103, having a surface of raised polymer dots 104.

FIG. 2 shows a second embodiment of the present invention in which a second layer of non-woven synthetic fabric 105 is bonded to the second face of the asphalt felt layer 100, utilizing a second adhesive 106.

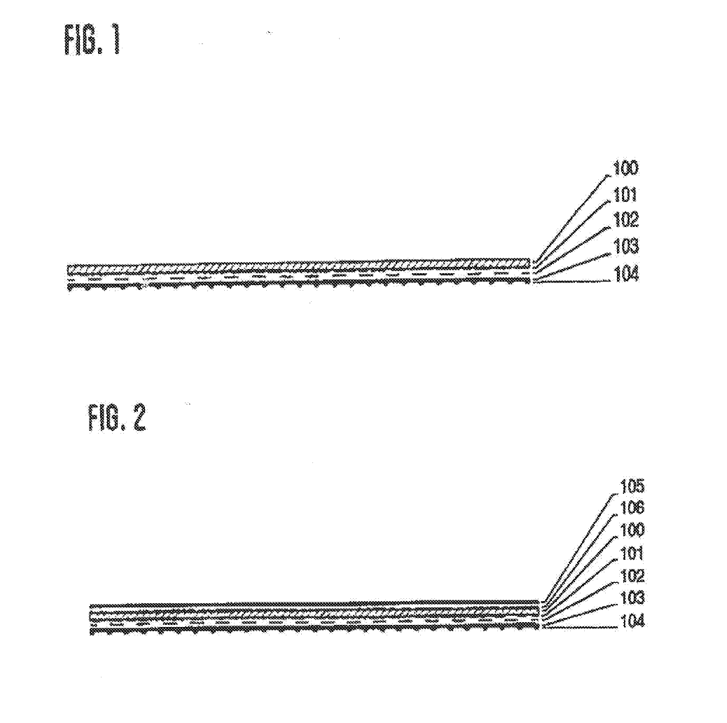

### DETAILED DESCRIPTION

Accordingly the main embodiments of the present invention are described as:

An improved composite sheet made of asphalt impregnated felt paper which is spot-coated with closely spaced spots of a hot-melt adhesive on one face to which a ply of non-woven synthetic fabric is pressed and bonded to this face in a continuous process on a machine designed for laminating materials.

The resulting composite lamination results in a sheet which has the strength and stability of the non-woven synthetic fabric while retaining the water resistance and permeability of the asphalt felt. A fiberglass scrim may also be sandwiched within the described lamination to add further strength.

And a second ply of non-woven fabric may be bonded to the second face of the asphalt felt sheet to further enhance its strength.

A further unique innovation of the present invention is to utilize a non-woven synthetic fabric having an anti-skid surface on one of its faces in order to provide enhanced foot traction for workers on sloped roofs. The anti-skid surface may consist of a grid of evenly spaced raised polymer dots on one surface of the non-woven sheet, which dots are about 2 mm wide by 1 mm in height and spaced about 6 mm apart.

The raised dots of the present invention can also serve to create a thin air gap beneath any roofing material such that the gap can help drain errant moisture and also permit some wind driven air movement to occur beneath roofing layers to assist in moisture removal.

A further innovation of the present invention is to use polymer modified asphalt in hot molten form for the laminating adhesive which is applied in a closely spaced spot-coated manner to maintain windows of permeability. This unique method of bonding results in a very rapidly setting bond which permits high speed production and still maintains the water vapor permeability of the laminated sheet.

Other common adhesives may also be used and applied in a spot coated manner in order to maintain permeability. Chloroprene is an example of one such adhesive.

While these are the preferred embodiments of the present invention, various other materials or arrangements of components can be utilized by those skilled in the art to achieve a finished material possessing the described characteristics of the present invention. Some but not all examples of variations are:
a. Asphalt saturated Kraft paper may be used instead of roofing felt.
b. A woven polymer sheet may be used in place of the non-woven fabrics.
c. A non-woven fabric sheet without the anti-skid polymer dots may be used.
d. The non-woven or woven polymer sheets may be comprised of other polymers such as polyethylene, polypropylene, polyester and similar materials.

We claim:

1. A multi-layer laminated roofing underlayment comprising a sheet of asphalt impregnated felt paper bonded to a sheet of porous non-woven polymer fabric in which the bonding adhesive is hot-melt modified asphalt, spot coated onto the felt paper in order to maintain water vapour permeability.

2. A multi-layer laminated roofing underlayment according to claim 1, where an open grid fiberglass scrim is incorporated within the lamination.

3. A multi-layer laminated roofing underlayment according to claim 2, where one face of the said porous non-woven polymer fabric has an anti-skid surface of 1 mm high raised polymer dots spaced about 6 mm apart in all directions.

4. A multi-layer laminated roofing underlayment according to claim 3, where the hot-melt adhesive spot coating procedure leaves sufficient uncoated voids resulting in a minimum water-vapor permeance of 5 Perms in the described lamination.

5. A multi-layer laminated roofing underlayment according to claim 1 where the porous non-woven polymer fabric has a basis weight ranging between 50 gsm (grams per square meter) to 250 gsm, with a preferred basis weight of 100 gsm.

6. A multi-layer laminated roofing underlayment according to claim 1, where the asphalt impregnated felt paper has a basis weight ranging between 90 gsm to 1350 gsm with a preferred basis weight of about 500 gsm.

7. A multi-layer laminated roofing underlayment according to claim 1 where a second sheet of porous non-woven fabric is bonded to the second face of the asphalt impregnated felt paper using a thinly spread fast-setting adhesive such as Chloroprene applied in a manner which maintains the water vapour permeability of the laminated sheet.

8. Providing a thin gap for drainage and air flow beneath a roofing material with the embodiment of raised dots on the surface of an underlayment sheet.

9. A hot melt adhesive according to claim 1 wherein the bonding asphalt has a penetration rating between 80 to 100 mm and the modifying polymer is a a styrene-butadiene-stryrene, SBS, polymer combined with a styrene-isoprene-styrene, SIS, polymer designed to produce an elastomeric compound having high strength bonding properties.
